(19) United States
(12) Patent Application Publication
(10) Pub. No.: US 2006/0059041 A1
(43) Pub. Date: Mar. 16, 2006

(54) System and method for advertising on donated equipment

(76) Inventor: Mark A. Heistand, Parker, CO (US)

Correspondence Address: Mark J. Young, Suite 227, 9951 Atlantic Blvd., Jacksonville, FL, 32225, US

(21) Appl. No.: 10/938,280

(22) Filed: Sep. 10, 2004

(51) Int. Cl. G06Q 30/00

(52) U.S. Cl. 705/14

(57) ABSTRACT

A method for advertising on donated equipment includes steps of matching a donor to a donee; identifying equipment to be donated; establishing a donation agreement; displaying an advertisement on the equipment in accordance with the donation agreement; and using the equipment in accordance with the donation agreement. A system for facilitating advertising on donated equipment includes a computer server configured for network access by a donor and a donee; a donee module is configured to receive and store donee and equipment information on the server; and a donor module configured to facilitate searching donee and equipment information.

### FIELD OF THE INVENTION

The present invention relates generally to the fields of charity and advertising. More specifically, the invention relates to an advertising system and method that utilizes donated emergency equipment to display a donor's advertisement while making the equipment available for use in emergencies.

### BACKGROUND

Businesses have implemented various marketing techniques to promote their brand, engender goodwill and improve name recognition in the marketplace. Marketing campaigns are typically considered successful if they positively affect customer loyalty, brand name awareness and recognition, product distribution and the like.

One marketing technique, display advertising, is widely used because of its perceived ability to reach a broad range of potential consumers. The advertising may take the form of a billboard, other signage, naming rights at a sports stadium or the like. The return for the investment is merely a likelihood that many potential consumers will take notice and remember the brand. It is typically unclear how many potential consumers take notice and how much business (if any) can be attributed to the display. However, it is clear that the display does little more than showcase the brand name to the public.

A seemingly unrelated problem is a chronic shortage of emergency vehicles and equipment. Firefighters, police, emergency medical technicians, terrorist response teams and other rescue personnel require specialized vehicles and equipment to provide emergency services. Often, the unavailability of funds to purchase additional vehicles and equipment severely constrains an organization's ability to effectively provide emergency services when needed. As a result, for example, a wildfire may burn out of control destroying everything in its path because insufficient firefighting vehicles are available, or a stranded driver of a motor vehicle may be swept away in a flash flood because a rescue helicopter was unavailable, or victims of terrorism may go unattended for hours or days because there is limited terrorist response equipment.

A system and method are needed to facilitate marketing while solving shortages of emergency vehicles and equipment. The invention is directed to overcoming one or more of the problems as set forth above.

### SUMMARY OF THE INVENTION

To solve one or more of the problems set forth above, in an exemplary implementation of the invention, a method for advertising on donated equipment is provided. The method includes steps of matching a donor to a donee; identifying equipment to be donated; establishing a donation agreement; displaying an advertisement on the equipment in accordance with the donation agreement; and using the equipment in accordance with the donation agreement.

The donee is an entity in need of equipment and receptive to using donated equipment that displays a donor's advertisement. The donor is an entity interested in promoting its name or brand and willing to provide equipment to a donee for the donee's use. In consideration for receiving the donated equipment, the donee permits the donor to advertise on the equipment, in accordance with the donation agreement. The donor may transfer ownership of the equipment to the donee, or retain ownership and lease the equipment (at no cost or at a cost that is substantially below fair market value) to the donee.

A system for facilitating advertising on donated equipment is also provided. The system includes a computer server configured for network access by a donor and a donee. A donee module is configured to receive and store donee and equipment information on the server. A donor module is configured to facilitate searching donee and equipment information. A donation agreement module is configured to facilitate establishing a donation agreement between a donor and donee.

### BRIEF DESCRIPTION OF THE DRAWINGS

The foregoing and other objects, aspects and advantages of embodiments of the invention will be better understood from the following detailed description with reference to the drawings, in which:

FIG. 1 shows a high-level flowchart of an exemplary methodology according to the invention; and

FIG. 2 shows a high-level block diagram of a computer network upon which an exemplary implementation of the invention may be implemented; and

FIG. 3 shows a vehicle with an advertisement according to an exemplary implementation of the invention.

### DETAILED DESCRIPTION

Systems and methods consistent with the present invention enable a donor to acquire and donate equipment to a donee. The donated equipment is preferably emergency equipment upon which an advertisement may be displayed by the donor. A donation agreement between the donor and donee governs ownership and use of the equipment.

A donor is an entity interested in promoting its name or brand and willing to provide equipment to a donee for the donee's use. In consideration for receiving the donated equipment, the donee permits the donor to advertise on the equipment. The donor may transfer ownership of the equipment to the donee, or retain ownership and lease the equipment (at no cost or at a cost that is substantially below fair market value) to the donee. The donor entity may be any business or organization that has a need for marketing.

A donee is an entity in need of equipment and receptive to using donated equipment that displays a donor's advertisement. By way of example and not limitation, the donee may be a fire department, police department, medical organization or other business or organization that provides other provider of emergency services. The donee may be a suitable non-profit organization, having a 501(c)(3) tax exempt status, establishing a tax deduction for the charitable contribution of the donors.

The equipment donated by the donor is equipment upon which an advertisement may be displayed by the donor. Preferably, in normal use, the equipment will be exposed to the public. By way of example and not limitation, the equipment may include a fire truck, other firefighting or emergency equipment, vehicles used by the donee, police vehicles, ambulances, vehicles used by charitable organizations and the like.

The advertisement, which is comprised of the donor's name or brand, is conspicuously displayed on the donated equipment in a manner that does not compromise utility of the equipment to the donee. Many viewers of the equipment will notice the advertisement and associate the name or brand with a significant charitable contribution for the public's benefit. The audience may include a wide array of viewers such as people who use and maintain the equipment, people at a location where the equipment is traveling or being used, television viewers, and readers who see the vehicle in printed publications.

The donation agreement provides a structured framework for governing the relationship between the donor and donee. The agreement will address key issues such as acquisition, advertisement, use, ownership and disposition of the equipment. The agreement may be written (e.g., in printed, electronic and/or other form) or oral, though written agreements are preferred. The agreement may be a binding, legally enforceable agreement, or a mere informal understanding between the parties. However, a binding, legally enforceable agreement is preferred.

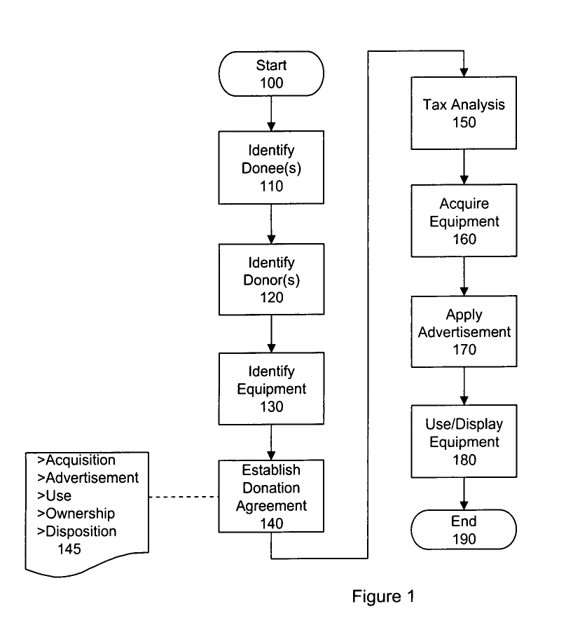

Referring now to FIG. 1 a high-level flowchart of an exemplary methodology according to the invention is shown. An initial step 110 involves identifying one or more prospective donees. Donees may be identified individually or in groups, and according to various categories such as the type of services provided by the donee and/or the equipment needed by the donee, and/or the geographic location of the donees. The objective is to identify entities in need of emergency equipment upon which an advertisement may be displayed. Donors, marketing agents or other persons or entities may identify donees by contacting them directly or indirectly via a website (as discussed below). Alternatively, donees may identify themselves and their needs to donors, marketing agents or a website.

One or more donors are also identified, as in step 120. Donors may be identified individually or in groups, and according to various categories such as type of business, size of the donor, revenue, and/or geographic location. An objective of this step is to identify entities with the resources to donate emergency equipment in consideration for a meaningful advertisement opportunity. Donees, marketing agents or other persons or entities may identify donors by contacting them directly or indirectly via a website (as discussed below). Alternatively, donors may identify themselves to donees, marketing agents or a website.

Equipment to be donated is also identified, as in step 130. The equipment should be assets needed by a donee and suitable for displaying an advertisement by a donor. Preferably, in normal use, the equipment will be exposed to the public and used for laudable purposes. An objective of this step is to identify equipment that will provide a meaningful advertisement opportunity. Donees, marketing agents or other persons or entities may identify equipment. Alternatively, donors may propose equipment to donate to donees, marketing agents or a website.

Those skilled in the art will appreciate that the invention involves matching a donor to a donee for donation of equipment. Steps 110-130 of the exemplary methodology comprise matching a donor to a donee for donation of equipment.

When a donee, donor and equipment have been identified, the donor and donee may enter a donation agreement, as in step 140. The donation agreement provides a structured framework for governing the relationship between the donor and donee. The agreement will address key issues such as acquisition, advertisement, use, ownership and disposition of the equipment.

An acquisition section of the donation agreement may address purchase, delivery and tax treatment for the equipment. By way of example and not limitation, pursuant to the donation agreement, the donor may purchase the equipment and transfer ownership or lease the equipment to the donee. Alternatively, the donor may fund the donee's purchase or lease of the equipment. The terms and conditions of a lease, if applicable, may be set forth in the agreement. In addition to addressing how acquisition of the equipment will be funded, the donation agreement may address when the acquisition will occur and where the acquired equipment will be delivered. The donor and donee may also agree on how each party will treat the acquired equipment for tax purposes.

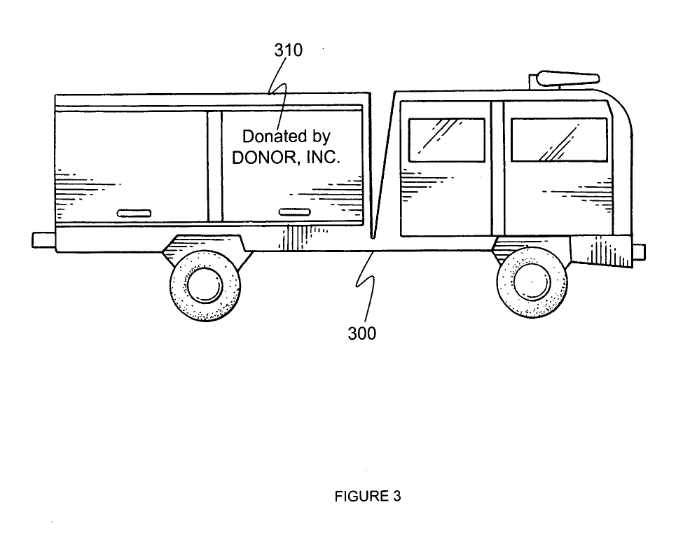

An advertisement section of the donation agreement may address content and appearance of the advertisement. By way of example and not limitation, a donor and donee may agree that the donor's name 310 will be conspicuously displayed on each side of a fire truck 300 acquired for the donee, as conceptually shown in FIG. 3. The size, color and placement of the advertisement may be addressed in the advertisement section.

Additionally, the advertisement section may allocate responsibility for applying the advertisement. The equipment may be purchased with the advertisement or the advertisement may be applied after the equipment is purchased. If the advertisement will be applied after acquisition, the agreement should define each party's rights and obligations in connection therewith. For example, the agreement may require the donee to make the equipment available on certain dates and at a certain location for application of the advertisement.

A use section of an exemplary donation agreement may address commitments and limitations on use of the equipment. The agreement preferably allows the donee to use the equipment as needed for rendering emergency services. The use section may also require the donee to maintain the equipment in proper working order and good appearance, at least for a defined period of time, such as the useful life of such equipment. Additionally, the use section may require the donee to periodically, if practicable, either use the equipment in public events or make it available for use in public events such as demonstrations, shows and parades. This aspect of the agreement helps ensure favorable public exposure to the advertisement.

The agreement may also address ownership of the equipment. If the donor purchases the equipment and transfers ownership to the donee, the donee would become the owner. If the donor funds the donee's purchase of the equipment, again the donee would become the owner. However, if the donor purchases the equipment and leases it to the donee, the donee would be a lessee. Likewise, if the donor funds the donee's lease of the equipment, the donee would become the lessee.

The agreement may also address revocability and transferability or disposition of the equipment. For example, a donor will probably want the agreement to prohibit or limit the donee from reselling the equipment without the donor's express approval, which may be conditioned. Illustratively, the agreement may prohibit any resales within a determined period of time (e.g., seven years) after the donation. To further protect its interests, the donor may require a right of first refusal. Thus, if the donee intended to resell the equipment far below fair market value, the donor would have a meaningful opportunity to repurchase the equipment.

The donation agreement may also define termination rights, and specify remedies for noncompliance. In one embodiment of the invention, the donation agreement is a written hardcopy instrument. In another embodiment, as discussed more fully below, the donation agreement is presented and assented to electronically.

An exemplary methodology according to the invention also includes a step of analyzing tax and accounting ramifications of the arrangement, as in step 150. The tax and accounting analysis may address issues such as whether the donation is a deductible charitable contribution and, if so, what the fair market value should be. The tax and accounting analysis may also address whether the equipment is an asset that may be depreciated. Because the tax and accounting consequences may have a substantial impact on the donor's tax liability and financial statements, this step is considered an important part of the exemplary methodology, one that should be performed with advice from a financial and tax professionals. Private letter rulings or similar opinions from taxing authorities such as the U.S. Internal Revenue Service may also be obtained.

Once threshold steps have been performed, the equipment may acquired, as in step 160, in accordance with the donation agreement. The advertisement may also be applied, as in step 170, in accordance with the donation agreement. Use of the equipment and display of the advertisement may then proceed, as in step 180, in accordance with the donation agreement.

A significant influence on developing effective advertising is coordination of awareness levels with consumer exposure to company and product names. Emergencies, rescues and special events tend to stimulate attention. The proposed methodology places the donor's name or brand in the center of an emergency response, rescue or display event. Many viewers of the equipment will notice the advertisement and associate the name or brand with a laudable charitable contribution for the public's benefit.

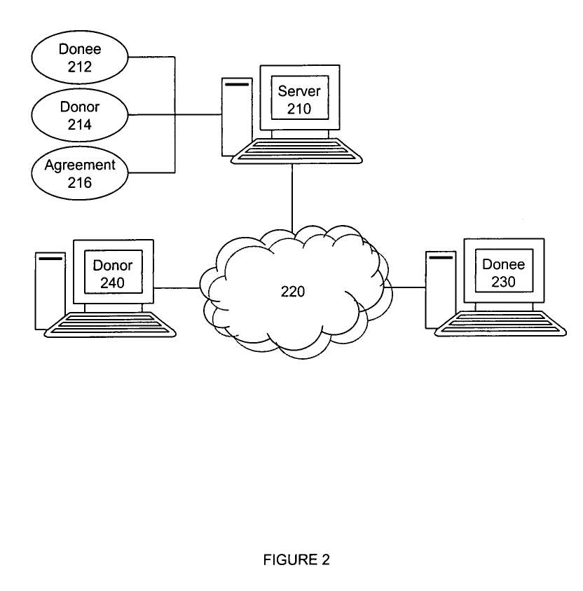

Referring now to FIG. 2, a high-level block diagram of an online system in accordance with an exemplary implementation of the invention is shown. A server 210 hosts software for storing data and performing functions according to the invention. Donors and donees using computing devices 230-240 access the server 210 to perform various functions, such as registering, managing accounts, updating account information, and performing transactions. Access to the server 230-240 by the plurality of donees and donors 230-240 is preferably via one or more data communications networks, which may include the Internet 220.

An exemplary server 210 is comprised of a computer system, having a bus for communicating information, a central processing unit (CPU), a read only memory (ROM), a random access memory (RAM), a mass storage device, and communications equipment. The storage device may include a hard disk, CD-ROM drive, DVD drive, tape drive, memory (e.g., RAM, ROM, Compact Flash RAM, PCMCIA RAM) and/or other storage equipment. An input device such as a keyboard, touch sensitive screen, a pointing device (e.g., a computer mouse, touch pad or joystick) and the like may also be provided. Software such as network operating system software is stored on and executable on the server 210. These elements are typically included in many computer servers. Indeed, the aforementioned server 210 is intended to represent a broad category of computer systems capable of functioning as a computer server and hosting application software for network access and use by donors and donees in accordance with the present invention. Of course, the server 210 may include fewer, different and/or additional elements, functioning as a single server or as a distributed system, provided it is capable of performing functions in accordance with the present invention.

The server 210 hosts (i.e., provides donors and donees with access to) information, documents and software needed to provide functionality and enable performance of methodologies in accordance with an exemplary embodiment of the invention. For example, the server 210 may include web page information and documents (e.g., HTML and XML code), applets and application software and other forms of executable instructions (referred to collectively herein as modules), which manage donee and donor access and use, processes transactions and manage databases for donor and donee data.

Donors and donees access the server 210 using compatible computing devices 230-240 with network connectivity. By way of example, such devices 230-240 may include personal computers, personal digital assistants or any similarly equipped electronic computing devices. Although one donor and one donee computer 230-240 are shown for illustrative purposes, any number of donee and donor computers may be used in accordance with the invention. Additionally, various forms of network connectivity may be used by the donor and donee computers 230-240 to access the server. Donor and donee systems may include an operating system, a web browser configured to display HyperText Markup Language (HTML) documents sent by the server system. Such browsers may also utilize client-side scripting languages such as Javascript and VB Script.

In one embodiment, information pertaining to prospective donees and their needed equipment is posted on the server 210 using a donee module 212 for accessibility on a website via the Internet. The information may be posted by donees or other parties for the benefit or on behalf of donees. The posted information may include a description of the donee, the donee's needs for equipment, the donee's tax status (e.g., whether the donee is qualified as a non-profit organization), the donee's geographic areas of service, special events (e.g., parades) in which the donee participates, and other information which may help a donor make an intelligent and informed donation decision. Some or all of the donee information may be stored in a database for access and searching by donors. A search engine may be provided to enable searching of some or all information posted by donees. Filtering tools may be provided so that search results may be filtered according determined categories.

Donors may access the server 210 to perform various functions using a donor module 214, such as identifying donees in need of equipment that the donor may be willing to donate in accordance with the invention. Donors may search for donees by industry segment or according to donee tax status, various the type of services provided by the donee, equipment needed by the donee, and/or the geographic location of the donees. The networked system facilitates identifying the best match between donees in need of emergency equipment upon which an advertisement may be displayed and donors willing to provide the equipment in exchange for an advertising opportunity.

The server 210 may also facilitate establishing a donation agreement using a donation agreement module 216. Default standard donation agreements may be stored on the server 210 and made accessible to donors and donees for use by the parties as a starting point. The parties may edit and negotiate the agreement and upload edited versions of the agreement to the server 210. When the parties mutually agree upon an edited version of the agreement, they may upload that version of the agreement and express their assent. An accept button may associate a party's assent with an agreement. The date, and the name and title of the person who clicks the accept button may be required and associated with that version of the agreement. Thus, the system facilitates matching donors and donees and establishing an agreement to govern advertising and use of donated equipment.

Those skilled in the art will appreciate that a system according to the invention can utilize many different types of communications networks. For example, a proprietary Wide Area Network (WAN) or a public WAN such as the Internet may be used. These networks typically employ various protocols such as the HyperText Transfer Protocol (HTTP), Extensible Markup Language (XML), and Transfer Control Protocol/Internet Protocol (TCP/IP) to communicate information between remote computer systems. A system according to the present invention may also utilize wireless networks, including those utilizing Global System for Mobile (GSM), Code Division Multiple Access (CDMA) or Time Division Multiple Access technology, and the Wireless Application Protocol (WAP). A system according to the invention may utilize any, or any combination of, such communications networks. As such, although the donor and donee systems 230-240 are represented as being personal computer systems, as discussed above, any electronic device capable of interfacing with a communications network may be used, including kiosks, personal digital assistants and mobile phones.

While the invention has been described in terms of various embodiments and implementations, those skilled in the art will recognize that the invention can be practiced with modification within the spirit and scope of the appended claims.

We claim the following:

1. A method for advertising on donated equipment comprising:
matching a donor to a donee;
identifying equipment to be donated;
establishing a donation agreement;
displaying an advertisement on the equipment in accordance with the donation agreement; and
using the equipment in accordance with the donation agreement.

2. The method of claim 1, wherein the step of matching a donor to a donee includes identifying a donee in need of equipment.

3. The method of claim 1, wherein the step of matching a donor to a donee includes identifying a donor interested in donating equipment.

4. The method of claim 1, wherein the step of matching a donor to a donee includes identifying a donor interested in donating equipment in exchange for advertising on the equipment.

5. The method of claim 1, wherein the step of identifying equipment includes identifying equipment for donation by the donor to the donee, said equipment being suitable for displaying an advertisement, and said equipment being needed by the donee.

6. The method of claim 1, wherein the equipment is equipment from the group consisting of emergency service equipment and rescue equipment.

7. The method of claim 1, wherein the step of establishing a donation agreement includes entering a binding, legally enforceable agreement between the donor and donee.

8. The method of claim 1, wherein the step of establishing a donation agreement includes entering a donation agreement that addresses at least one issue form the group consisting of acquisition, advertisement, use, ownership and disposition of the equipment.

9. The method of claim 1, wherein the step of establishing a donation agreement includes entering a written donation agreement.

10. The method of claim 1, wherein the step of establishing a donation agreement includes entering a oral donation agreement.

11. A method for advertising on donated equipment comprising:
matching a donor to a donee;
identifying equipment to be donated;
establishing a donation agreement;
displaying an advertisement on the equipment in accordance with the donation agreement; and
using the equipment in accordance with the donation agreement;
wherein the step of matching a donor to a donee includes identifying a donee in need of equipment and identifying a donor interested in donating equipment in exchange for advertising on the equipment.

12. The method of claim 11, wherein the step of identifying equipment includes identifying equipment for donation by the donor to the donee, said equipment being suitable for displaying an advertisement, and said equipment being needed by the donee.

13. The method of claim 12, wherein the equipment is equipment from the group consisting of emergency service equipment and rescue equipment.

14. The method of claim 13, wherein the step of establishing a donation agreement includes entering a binding, legally enforceable agreement between the donor and donee.

15. The method of claim 13, wherein the step of establishing a donation agreement includes entering a donation agreement that addresses at least one issue form the group consisting of acquisition, advertisement, use, ownership and disposition of the equipment.

16. The method of claim 13, wherein the step of establishing a donation agreement includes entering a written donation agreement.

17. The method of claim 13, wherein the step of establishing a donation agreement includes entering a oral donation agreement.

18. A system for facilitating advertising on donated equipment comprising:
a server configured for network access by a donor and a donee;
a donee module configured to receive and store donee and equipment information on the server; and
a donor module configured to facilitate searching donee and equipment information.

19. A system for facilitating advertising on donated equipment according to claim 18, said system further comprising a donation agreement module configured to facilitate establishing a donation agreement between a donor and donee.

20. A system for facilitating advertising on donated equipment according to claim 18, wherein said donee and equipment information include a description of the donee and information pertaining to the donee's needs for equipment, the donee's tax status, the donee's geographic areas of service, special events in which the donee participates.
